(19) United States
(12) Patent Application Publication
(10) Pub. No.: US 2005/0174594 A1
(43) Pub. Date: Aug. 11, 2005

(54) System and method for identifying and charging for print requests

(76) Inventors: Darrel Cherry, Boise, ID (US); James Clough, Boise, ID (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/773,976

(22) Filed: Feb. 6, 2004

(51) Int. Cl. G06F 3/12; G06F 15/00; G08B 29/00; H04L 9/32; G06F 17/60

(52) U.S. Cl. 358/1.14; 340/5.21; 705/39

(57) ABSTRACT

Systems, methods, computer-readable medium, graphical user interfaces, print drivers, and other embodiments associated with processing print requests is provided. In one example system, the system comprises a print delay logic configured to delay processing of print requests until a selected print request is claimed. An input device can be configured to receive a claim request from a user desiring to claim one or more print requests, the claim request including charge account information. An identification logic can be configured to identify one or more print requests for which the user is an owner based, at least in part, on the claim request, and can be configured to cause the identified one or more print requests to be processed. A payment logic can be configured to charge an account using the charge account information from the claim request.

### BACKGROUND

Public areas may include computers and printers that allow users to print desired files, images, or other objects. When a print job is submitted to a public printer, the print job is typically printed automatically, for example, based on the order it was received. The user can then retrieve the printed job from the printer. However, printed jobs may remain in the open and accessible for other people to see and/or take. In some environments, a printer may be maintained behind a counter and the user is required to pay for a print job before the printed job can be retrieved from the personnel operating the printer. However, print jobs may be printed and abandoned without receiving payment, thereby wasting the resources of the printer.

### BRIEF DESCRIPTION OF THE DRAWINGS

The accompanying drawings, which are incorporated in and constitute a part of the specification, illustrate various example systems, methods, and so on that illustrate various example embodiments of aspects of the invention. It will be appreciated that the illustrated element boundaries (e.g., boxes, groups of boxes, or other shapes) in the figures represent one example of the boundaries. One of ordinary skill in the art will appreciate that one element may be designed as multiple elements or that multiple elements may be designed as one element. An element shown as an internal component of another element may be implemented as an external component and vice versa. Furthermore, elements may not be drawn to scale.

FIG. 1 illustrates an example print request processing system.

FIG. 2 illustrates an example methodology associated with delaying a print request until physically claimed.

FIG. 3 illustrates an example image forming device for receiving and claiming print requests.

FIG. 4 illustrates an example methodology associated with claiming a print request.

FIG. 5 illustrates another example print request processing system that identifies and charges for print requests.

FIG. 6 illustrates another example image forming device including a print request processing system.

FIG. 7 illustrates an example graphical user interface.

FIG. 8 illustrates an example print driver.

### DETAILED DESCRIPTION

The following includes definitions of selected terms employed herein. The definitions include various examples and/or forms of components that fall within the scope of a term and that may be used for implementation. The examples are not intended to be limiting. Both singular and plural forms of terms may be within the definitions.

“Computer-readable medium”, as used herein, refers to a medium that participates in directly or indirectly providing signals, instructions and/or data. A computer-readable medium may take forms, including, but not limited to, non-volatile media, volatile media, and transmission media. Non-volatile media may include, for example, optical or magnetic disks and so on. Volatile media may include, for example, optical or magnetic disks, dynamic memory and the like. Transmission media may include coaxial cables, copper wire, fiber optic cables, and the like. Transmission media can also take the form of electromagnetic radiation, like those generated during radio-wave and infra-red data communications, or take the form of one or more groups of signals. Common forms of a computer-readable medium include, but are not limited to, a floppy disk, a flexible disk, a hard disk, a magnetic tape, other magnetic medium, a CD-ROM, other optical medium, punch cards, paper tape, other physical medium with patterns of holes, a RAM, a ROM, an EPROM, a FLASH-EPROM, or other memory chip or card, a memory stick, a carrier wave/pulse, and other media from which a computer, a processor or other electronic device can read. Signals used to propagate instructions or other software over a network, like the Internet, can be considered a “computer-readable medium.”

“Data store”, as used herein, refers to a physical and/or logical entity that can store data. A data store may be one or more of, for example, a database, a table, a file, a list, a queue, a heap, a memory, a register, and so on. A data store may reside in one logical and/or physical entity and/or may be distributed between two or more logical and/or physical entities.

“Logic”, as used herein, includes but is not limited to hardware, firmware, software and/or combinations of each to perform a function(s) or an action(s), and/or to cause a function or action from another component. For example, based on a desired application or needs, logic may include a software controlled microprocessor, discrete logic like an application specific integrated circuit (ASIC), a programmed logic device, a memory device containing instructions, or the like. Logic may also be fully embodied as software. Where multiple logical logics are described, it may be possible to incorporate the multiple logical logics into one physical logic. Similarly, where a single logical logic is described, it may be possible to distribute that single logical logic between multiple physical logics.

An “operable connection”, or a connection by which entities are “operably connected”, is one in which signals, physical communication flow, and/or logical communication flow may be sent and/or received. Typically, an operable connection includes a physical interface, an electrical interface, and/or a data interface, but it is to be noted that an operable connection may include differing combinations of these or other types of connections sufficient to allow operable control. For example, two entities can be operably connected by being able to communicate signals to each other directly or through one or more intermediate entities like a processor, an operating system, a logic device, software, or other entity. Logical and/or physical communication channels can be used to create an operable connection.

“Signal”, as used herein, includes but is not limited to one or more electrical or optical signals, analog or digital signals, data, one or more computer or processor instructions, messages, a bit or bit stream, or other means that can be received, transmitted and/or detected.

“Software”, as used herein, includes but is not limited to, one or more computer or processor instructions that can be read, interpreted, compiled, and/or executed and that cause a computer, processor, or other electronic device to perform functions, actions and/or behave in a desired manner. The instructions may be embodied in various forms like routines, algorithms, modules, methods, threads, and/or programs including separate applications or code from dynamically linked libraries. Software may also be implemented in a variety of executable and/or loadable forms including, but not limited to, a stand-alone program, a function call (local and/or remote), a servelet, an applet, instructions stored in a memory, part of an operating system or other types of executable instructions. It will be appreciated by one of ordinary skill in the art that the form of software may be dependent on, for example, requirements of a desired application, the environment in which it runs, and/or the desires of a designer/programmer or the like. It will also be appreciated that computer-readable and/or executable instructions can be located in one logic and/or distributed between two or more communicating, co-operating, and/or parallel processing logics and thus can be loaded and/or executed in serial, parallel, massively parallel and other manners.

Suitable software for implementing the various components of the example systems and methods described herein include programming languages and tools like Java, Pascal, C#, C++, C, CGI, Perl, SQL, APIs, SDKs, assembly, firmware, microcode, and/or other languages and tools. Software, whether an entire system or a component of a system, may be embodied as an article of manufacture and maintained as part of a computer-readable medium as defined previously. Another form of the software may include signals that transmit program code of the software to a recipient over a network or other communication medium. Thus in one example, a computer-readable medium has a form of signals that represent the software/firmware as it is downloaded from a web server to a user. In another example, the computer-readable medium has a form of the software/firmware as it is maintained on the web server. Other forms may also be used. It will be appreciated that components described herein may be implemented as separate components or may be combined together.

“User”, as used herein, includes but is not limited to one or more persons, software, computers or other devices, or combinations of these.

Some portions of the detailed descriptions that follow may be presented in terms of algorithms and symbolic representations of operations on data bits within a memory. These algorithmic descriptions and representations are the means used by those skilled in the art to convey the substance of their work to others. An algorithm is here, and generally, conceived to be a sequence of operations that produce a result. The operations may include physical manipulations of physical quantities. Usually, though not necessarily, the physical quantities take the form of electrical or magnetic signals capable of being stored, transferred, combined, compared, and otherwise manipulated in a logic and the like.

It has proven convenient at times, principally for reasons of common usage, to refer to these signals as bits, values, elements, instructions, symbols, characters, terms, numbers, or the like. It should be borne in mind, however, that these and similar terms are to be associated with the appropriate physical quantities and are merely convenient labels applied to these quantities. Unless specifically stated otherwise, it is appreciated that throughout the description, terms like processing, computing, calculating, determining, displaying, or the like, refer to actions and processes of a computer system, logic, processor, or similar electronic device that manipulates and transforms data represented as physical (electronic) quantities.

Described herein are example systems, methods, computer-readable media, print drivers, graphical user interfaces, and other embodiments associated with identifying and/or charging for print jobs. In one example system, print jobs/requests can be parked or otherwise delayed in an image forming device until they are claimed by their owner. To have a print request actually printed, a user can provide a credit card or other identification device to the image forming device in order to claim the print request. Providing the card indicates to the system that the user is physically present and is requesting to retrieve their print request. The data from the credit card can be used to identify delayed print requests that belong to the user and may also be used to pay for the print request by charging the credit card. The credit card data, for example, such as the user's name or last four digits of their card number, can be used to match identity information associated with each print request.

For image forming devices that are in a public venue, print requests are not printed until the owner physically claims the print request by swiping his/her credit card at the printer, or by providing other types of identification information. This may assist with security issues where printed documents are not printed for anyone to see or take, but rather, are printed when the owner is physically in the presence of the image forming device and is ready to retrieve his/her printed job. Additionally, by using a credit card or other card with charge account information, the image forming device can charge for the services of processing the print request by charging the credit card. Thus, in one example, identifying and charging for print requests can be performed in response to one action from a user such as a single data input (e.g. single swipe of a credit card). The single data input serves as both identifying information and charging information.

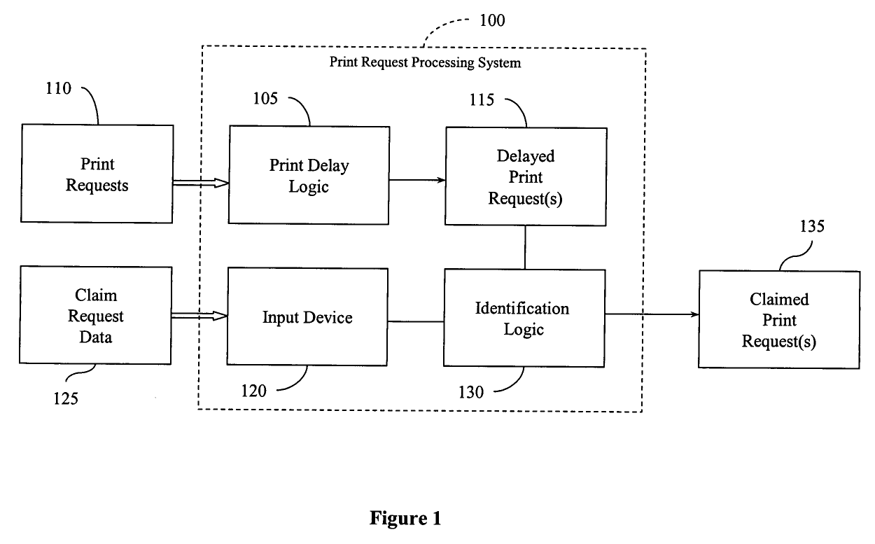

Illustrated in FIG. 1 is one example of a print request processing system 100 that can be configured to hold print requests in an image forming device until a print request is claimed or otherwise retrieved by a user that sent the print request. The print request processing system 100 can be local to an image forming device, can be part of a computer or print server in communication with the image forming device, or can be embodied in a different desired manner. The system 100 can be configured using any type of desired logic.

A print delay logic 105 can be configured to handle incoming print requests 110. The print requests 110 are initially held up and may be maintained in a pending state as delayed print requests 115. For example, the delayed print requests 115 can be held in a queue until they are claimed or retrieved by their owner. In that regard, an input device 120 can be provided that is configured to receive claim request data 125 from a user. The claim request data 125 can be any type of identification information such as a user's name and/or other identification information that can be used to associate the user to his/her delayed print request(s) 115. It is presumed that the delayed print request(s) 115 includes corresponding identification information that allows for the information to be compared with the claim request data 125. The configuration of the delayed print request(s) 115 will be described in greater detail below.

In one example, the input device 120 can be a magnetic card reader and the claim request data 125 can be the information obtained from a card read by the input device 120. Once the claim request data 125 is received, an identification logic 130 can be configured to match the claim request data 125 with identification data associated with each of the delayed print requests 115. Thus, the identification logic 130 can be configured to identify one or more print requests for which the user that inputted the claim request data 125 is an owner. The pending print request(s) belonging to the user are identified in FIG. 1 as claimed print request(s) 135.

It will be appreciated that the claim request data 125 may include more information than is necessary in order to identify a matching print request. For example, a credit card swiped in the input device 120 may provide a set of data but, the identification logic 130 may only use selected portions or sub-sets of the data in order to identify and associate with a matching print request. If a match is found, the identification logic 130 can be configured to cause the identified one or more delayed print requests to be processed by the image forming device into a printed job. In this manner, print requests can be delayed until physically claimed by a user so that documents are not printed until the user is physically present to retrieve the printed documents. It will be appreciated that when each of the print requests 110 are generated, owner identification is received from the user and associated with each print request so that the owner information can be used to match against the claim request data 125. Generating print requests will be described in greater detail below.

With further reference to FIG. 1, the input device 120 can, in one example, be a card reader or other information reading device configured to read identification data from an identification device provided by the user. The identification data, which becomes part of the claim request data 125, can also include charge account information. A payment logic (not shown) may also be provided that is configured to charge an account based on the charge account information. The identification device may be, for example, a credit card, a debit card, a student identification card, an employee identification card, an electronic device including logic, a computer-readable medium, or the like. The charge account information may be used to identify an account that can be charged based on the charge account information.

In another example, the input device 120 can include a key pad configured to allow a user to input an identification code such as a password, that can become part of the claim request data 125. The key pad can be used in combination with the card reader. Each delayed print request 115 can include owner identification that allows the identification logic 130 to compare the identification code (provided by the user) to the owner identification of each print request 115 to determine a match. If there is a match, the delayed print request 115 then becomes a claimed print request(s) 135 that can be sent for processing into a printed output. It will be appreciated that a data store can be used to maintain the delayed print requests 115 in any desired computer-readable medium, like a memory, within an image forming device.

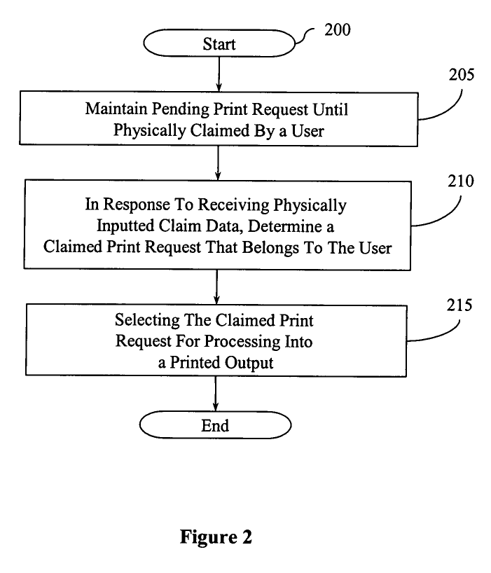

Illustrated in FIG. 2 is an example methodology 200 associated with processing print requests transmitted to an image forming device. While for purposes of simplicity of explanation, the illustrated methodologies are shown and described as a series of blocks, it is to be appreciated that the methodologies are not limited by the order of the blocks, as some blocks can occur in different orders and/or concurrently with other blocks from that shown and described. Moreover, less or more than all the illustrated blocks may be required to implement an example methodology. Furthermore, additional and/or alternative methodologies can employ additional, not illustrated blocks.

In the flow diagrams, blocks denote “processing blocks” that may be implemented with logic. A flow diagram does not depict syntax for any particular programming language, methodology, or style (e.g., procedural, object-oriented). Rather, a flow diagram illustrates functional information one skilled in the art may employ to develop logic to perform the illustrated processing. It will be appreciated that in some examples, program elements like temporary variables, routine loops, and so on are not shown. It will be further appreciated that electronic and software applications may involve dynamic and flexible processes so that the illustrated blocks can be performed in other sequences that are different from those shown and/or that blocks may be combined or separated into multiple components. It will be appreciated that the processes may be implemented using various programming approaches like machine language, firmware, procedural, object oriented and/or artificial intelligence techniques. The various actions illustrated and/or described herein can occur in serial, but also various actions could occur substantially in parallel.

With reference to FIG. 2, when a print request is received, the print request can be maintained as a pending print request until physically claimed by a user (Block 205). By holding print requests, theft of printed documents and/or viewing of confidential documents by unauthorized users may be prevented or at least reduced. In order to initiate printing of a print request, a user/owner would be required to be physically in the presence or vicinity of the image forming device and identify himself/herself to the image forming device. The identification can be performed by, for example, inputting or otherwise providing identification data, which will also be referred to herein as claim data.

In response to receiving the physically inputted claim data, the process can determine which pending print requests belong to the user (Block 210). If the inputted claim data matches with a pending print request, the print request becomes a claimed print request and is selected for processing into a printed output (Block 215). Optionally, if one or more print requests are validly claimed, the claimed print requests can be displayed to the user and the user may be allowed to selectively initiate printing of the print request that belongs to them.

It will be appreciated that the methodology 200 and the other methodologies described herein can be embodied as processor-executable instructions provided by a computer-readable medium. For example, processor-executable instructions can be provided that are configured to cause an image forming device, a computing device, or other logic to process print requests as described herein. The processing may include receiving a print request that includes an associated user identification; delaying the processing of the print request in the image forming device until the request is claimed by a user; and in response to receiving claim data from a user in the presence of the image forming device (e.g. physically inputting identification data), and the claim data can be compared with the user identification associated with the delayed print request. The print request can then be processed if the user identification matches the claim data.

The process 200 may also include maintaining the received print requests in a queue where the print requests are received from one or more sources and/or one or more users. Additionally, the process may be configured so that a user account can be automatically charged for the claimed print request based on the claim data received. As described previously, the claim data may include credit card or other charge account information that can be used to charge for the printing services of the image forming device. Optionally, the process may also perform a pre-authorization on a user account identified by the claim data prior to processing the print request. For example, a verification can be performed to validate that the user account is valid and has sufficient funds or charge limits available to cover the costs of printing the claimed print request(s).

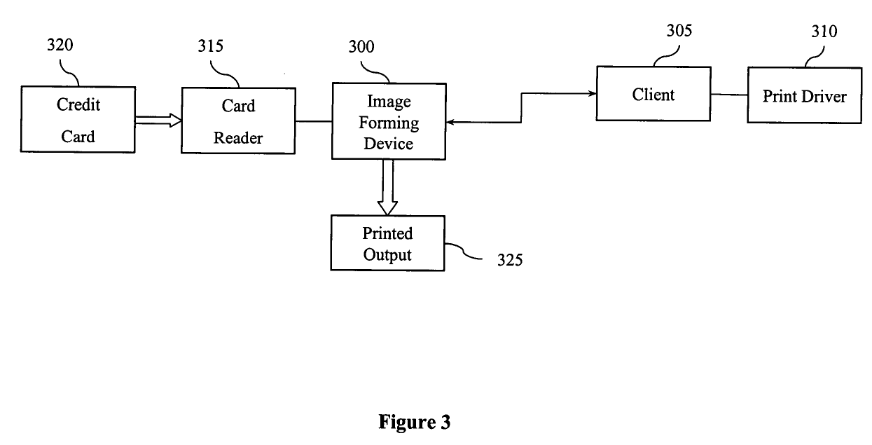

Illustrated in FIG. 3 is an example of an image forming device 300 configured to delay processing of print requests until retrieved by an owner of the print request. The image forming device 300 can be configured to receive print requests from one or more clients 305 such as computers, print servers, portable devices, or other device or service that can generate and transmit a print request. The client 305 can be in communication with the image forming device 300 by a variety of means such as direct connection, wireless connection, network connection, a connection through a print server, or other desired communication configuration and using any desired protocol.

The client 305 can include a print driver 310 configured to process print requests for a user. For example, the print driver 310 can include logic configured to generate a print request based on a selected data that is desired to be printed. The selected data can be, for example, a document, an image, a file, or other type of object that can be printed. The print driver 310 may also include logic configured to obtain, from the user, owner identification data to be embedded into the print request. For example, the print driver 310 may request a user's name, credit card information, other identification information, a password, and/or any combination of these. In the following example, it will be assumed that credit card information is used. The owner information (e.g. credit card information) can then combined or otherwise associated with the print request and transmitted to the image forming device 300.

As print requests are received by the image forming device 300, the print requests are delayed or otherwise maintained in a pending state until physically claimed by the user, for example, by providing claim data to the image forming device 300. The claim data will be used to match against the owner identification data in the pending print requests to determine ownership. A card reader 315 can be connected to the image forming device 300 where the card reader 315 is configured to accept or receive claim data or other type of identification data from a user. For example, the card reader 315 can be a credit card reader where a user can swipe a credit card 320 and the credit card data is used as claim data by the image forming device 300. By detecting a swipe of the credit card, the image forming device 300 can ensure that the user is physically present.

The credit card data can then be used to compare with the owner identification data embedded in pending print requests to determine if there is a match. If a match is found, meaning that the user who swipes the credit card 320 is the same user that initiated the print request on the client 305, the claimed print request is then processed into a printed output 325. In this example, the owner identification data inputted into the print driver 310 would include, for example, the user's name, the user's credit card number, selected portions or sub-sets of the credit card number (e.g. the last four digits), or other selected data that would be contained on the credit card so that a match can be determined. In another example, the user who claims the print request may not be the same user that generated the print request but may be an authorized agent, a co-owner of the credit card, and the like. In another example configuration, the logic to perform above-described processing and the card reader 315 may be local to a print server (not shown) that is in communication with the image forming device 300.

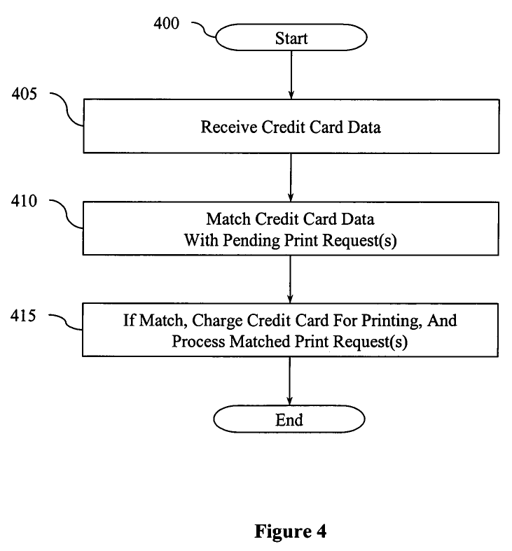

Illustrated in FIG. 4 is an example methodology 400 associated with identifying ownership of and charging for processing of print requests. In the example, it is assumed that print requests are being held in a pending state and have been preconfigured with identification data that will be used to identify the owner of each print request. The example will also be described with reference to a system that includes a credit card reader although other types of identification cards can be used that include identification of an account that may be charged. The process 400 can be triggered by the receipt of credit card data, for example, by reading a credit card that is swiped (Block 405). The credit card data can then be compared and matched with information associated with pending print requests (Block 410). For example, if the identification information associated with a print request includes the last four digits of a credit card, the last four digits of the inputted credit card data will be compared to determine if a match exists, thereby identifying ownership of the print request. If there is a match, the credit card can be charged for printing the print request(s) and the matched print request(s) can be processed into a hard copy (Block 415).

The process may include charging a flat fee for printing services, dynamically determining the cost of each print request, or using other types of cost calculating algorithms. For example, a print request may indicate the number of pages included in the request. The cost can then be calculated based on the number of pages and charged to the credit card. The process may also include verifying that the credit card is valid and/or has appropriate funds or limits before charging the account. It will be further appreciated that the credit card can be other types of cards that allow for the charging of an account.

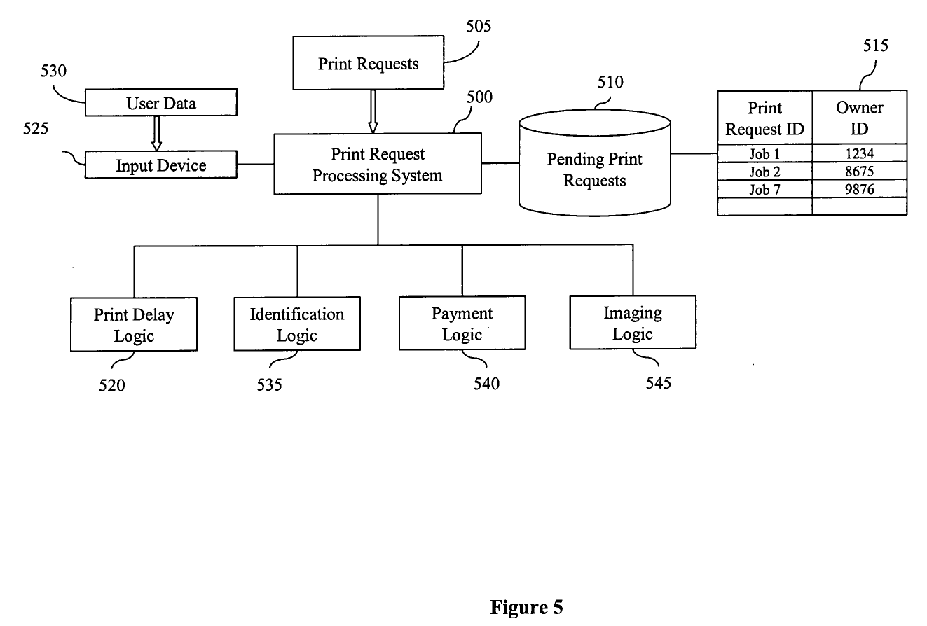

Illustrated in FIG. 5 is another example of a print request processing system 500 that is configured to process print requests 505 directed to an image forming device. The print request processing system 500 can be implemented in logic and can be implemented within or local to an image forming device, a computing device, a print server, or another desired component within an image processing system. As the print requests 505 are received, they can be held in a data store on a computer-readable medium as pending print requests or data store 510. Each print request may include owner information (e.g. an owner ID) associated with it such as a user's name, credit card number, password, other desired identification, and/or combination of these. The owner information can be attached to each print request in, for example, header information. The system 500 can be configured to analyze or otherwise parse each print request to identify, for example, a print request identifier and the owner identification. These identifiers and/or other data can be stored in a table 515 and/or memory that associates the print request ID and the owner ID together.

As print requests 505 are received, a print delay logic 520 can be configured to delay the processing of each print request by placing the print request in the data store 510 until it is claimed by an owner of the print request. An input device 525 such as a card reader can be provided and configured to read a credit card that is provided by a user who wishes to claim a pending print request. Optionally, a key pad can also be used to receive additional identification data that can be combined with credit card data, if desired. If successfully claimed, the print request can then be initiated for printing. The credit card data is one example of user data 530 that can be inputted into the input device 525 in order to claim a pending print request 510.

When the user data 530 is received, this event indicates that a user is physically present and is attempting to claim a print request. In response, an identification logic 535 can be configured to identify which of the pending print requests 510 in the data store are owned by the user by comparing the user data 530 (e.g. credit card data) with the owner information associated with the print requests, for example, the owner ID from the table 515. If a match is found, the associated pending print request can be selected for processing.

Optionally, a payment logic 540 may also be provided that is configured to charge the credit card read by the input device 525 for the services performed by the image forming device. An imaging logic 545 can be configured to cause the image forming device to print the matched print request(s) identified by the identification logic 535. This may include, for example, sending the matched print request to an imaging mechanism to be printed into a hard copy. As another example, the print request processing system 500 may include a display (not shown) configured to display the matched print requests that were identified as owned by the user using a graphical user interface.

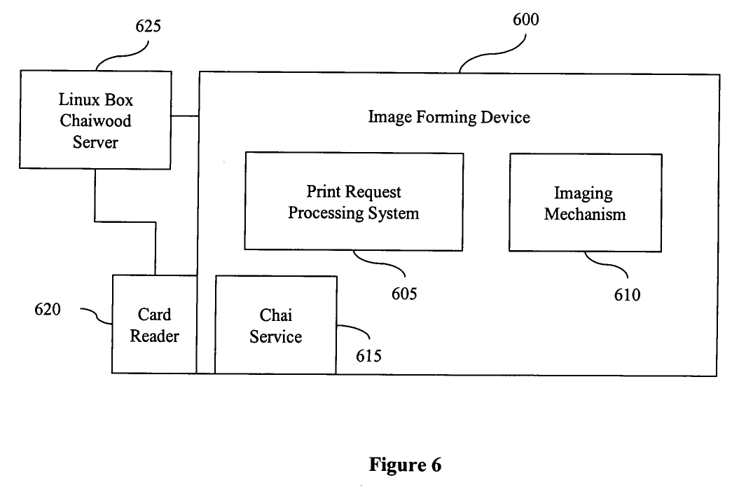

Illustrated in FIG. 6 is another example of an image forming device 600 that can include a print request processing system 605 that is configured like the system 100, the system 500, configured with combinations of these systems, or with similar components. The print request processing system 605 can be configured to delay the processing of print requests until physically claimed or retrieved by their owner. An imaging mechanism 610 can be included that is configured to generate a printed output on print media, in accordance with instructions and/or data from a print request.

In one example, the print request processing system 605 can be operated using a chai service 615 that is configured to execute logic or instructions, communicate with network devices, and communicate with a card reader 620 or other type of input device that can receive data from a user. The image forming device 600 can operate to delay processing of print requests until claimed by a user in one or more of the ways previously described. In another example, the image forming device 600 can be configured with a Linux box chaiwood server that is configured to control the operation of the card reader 620, control the operation of the print request processing system 605, and also perform communications with network devices or other external devices instead of having the chai service 615.

In one example, the chai service 615 can be a virtual machine configured to interpret and execute Java-like code. The chai service 615 can be configured to run chai servelets that perform desired functions associated with the processing of the print requests, as described, including the identification functions and/or charging functions. In another example, the Linux box chaiwood server 625 may be a computer or server connected to the image forming device 600 where the chaiwood server 625 is configured to receive print jobs and read identification card data and otherwise perform the functions of the print request processing system as described.

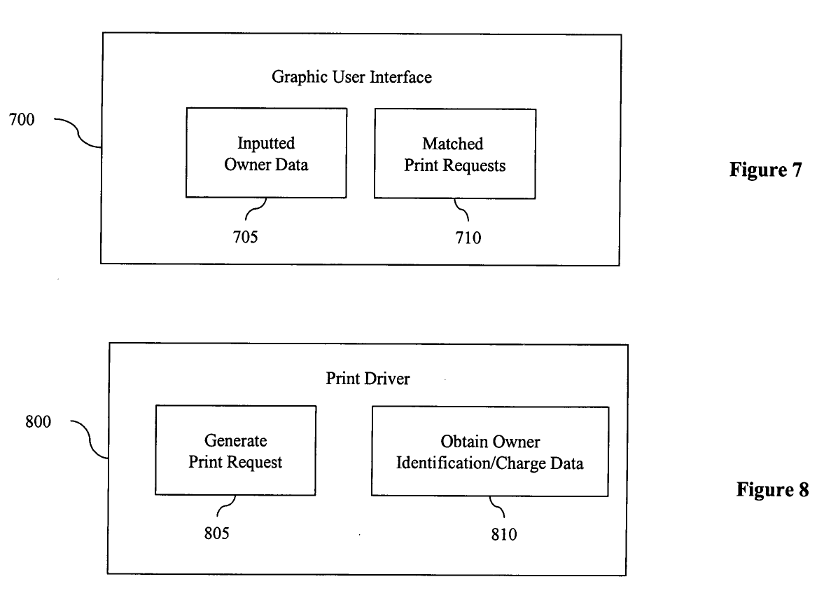

Illustrated in FIG. 7 is an example of a graphical user interface 700 that may be used with an image forming device or other computing device that processes print requests in a manner described above. For example, the graphical user interface 700 can include logic configured to display inputted claim/owner data 705 which may include information read from an identification card/credit card that is read by an input device. As previously described, a user may claim or otherwise retrieve print requests from an image forming device by entering owner data such as a credit card while in the vicinity of the image forming device. If the owner data (claim data) is matched with pending print requests, the logic can be configured to receive data representing the matched print requests that belong to a user. The claim data can include account information to allow an account to be charged for processing the one or more print requests claimed. The data from the matched print request(s) 710 can be displayed by the graphical user interface 700. In this manner, a user attempting to claim print requests can see on a display what his/her inputted owner data was and also see a list of one or more print requests that belong to them and are being held for processing. One or more of the matched print requests 710 can then be selected by the user and printing can be initiated as well as automatically charging a user account for the printing services.

Illustrated in FIG. 8 is an example of a print driver 800 that is configured to operate on a client device that can generate print requests for an image forming device that delays print requests until claimed by an owner. For example, the print driver 800 can include logic configured to generate a print request 805 and obtain owner identification/charge data 810 from the user requesting a print job. The identification/charge data 810 can then be embedded with the print request 805 and transmitted to an image forming device. As previously described, the owner identification/charge data 810 can include the user's name, a credit card number or portion thereof, or other desired type of identification data that can be subsequently used to identify the owner of the print request, or combinations thereof. In one example, the data 810 can be placed stored as header information with the print request. The print request can then be transmitted to a selected image forming device.

The print driver 800 can include logic to request identification information and/or billing information from a user and then inject or otherwise associate the identification information with the print request. This may be performed, for example, using a printer job language to embed attributes of the identification information. The identification attributes can be configured as meta data that is positioned in front of the print request data before it is sent to a printer. When received by the printer, the processing system can extract the meta data and store the meta data for subsequent identification with a user wishing to claim a print request. If a received print request does not include the appropriate meta data, the print request can be discarded and/or segregated for special processing. A received print request that has the appropriate meta data or other configuration is then configured to be maintained in a pending state in the image forming device until physically claimed by the user by providing a claim data to the image forming device that matches the owner identification data 810. The claim data can include identification information to identify the print request and charging information to charge a user account for processing the print request.

It will be appreciated that any of the described image forming devices, computing devices, logics, and print request processing systems can be configured to discard invalid print requests. For example, an invalid print request may be one that does not include owner identification/charge data, or a print request that includes data that cannot be recognized by the print request processing system. Invalid print requests may also be held separately for special identification and/or processing.

The following is an example application and scenario where the presently described embodiments may be implemented and used. For example, a user wishes to print a document from a computer. The computer is connected to a printer that is in a public location such as a library or coffee shop. Before submitting the print request, the computer obtains identity information from the user such as a name and/or credit card information. The identity information is combined with the print request and submitted to a print server or to the printer where the print request is held in a pending state. The user then walks over to the print server or printer and swipes their credit card in order to claim and retrieve their print request. The data read from the credit card is used to identify the user's pending print request, charge the credit card for printing services, and the print request is processed into a printed document. By having the user physically present to retrieve their print request, it may reduce the chances that the printed document is stolen or viewed by unauthorized people. Additionally, by not printing a print request until physically claimed, the resources of the printer can be better controlled by not permitting unauthorized print requests to be processed and by ensuring that services will be paid for.

While example systems, methods, and so on have been illustrated by describing examples, and while the examples have been described in considerable detail, it is not the intention of the applicants to restrict or in any way limit the scope of the appended claims to such detail. It is, of course, not possible to describe every conceivable combination of components or methodologies for purposes of describing the systems, methods, and so on described herein. Additional advantages and modifications will readily appear to those skilled in the art. Therefore, the invention, in its broader aspects, is not limited to the specific details, the representative apparatus, and illustrative examples shown and described. Accordingly, departures may be made from such details without departing from the spirit or scope of the applicants' general inventive concept. Thus, this application is intended to embrace alterations, modifications, and variations that fall within the scope of the appended claims. Furthermore, the preceding description is not meant to limit the scope of the invention. Rather, the scope of the invention is to be determined by the appended claims and their equivalents.

To the extent that the term “includes” or “including” is employed in the detailed description or the claims, it is intended to be inclusive in a manner similar to the term “comprising” as that term is interpreted when employed as a transitional word in a claim. Furthermore, to the extent that the term “or” is employed in the claims (e.g., A or B) it is intended to mean “A or B or both”. When the applicants intend to indicate “only A or B but not both” then the term “only A or B but not both” will be employed. Thus, use of the term “or” herein is the inclusive, and not the exclusive use. See, Bryan A. Garner, A Dictionary of Modern Legal Usage 624 (2d. Ed. 1995).

1. A system for processing print requests sent to an image forming device, the system comprising:
print delay logic configured to delay processing of print requests until a selected print request is claimed from the image forming device by an owner of the selected print request;
an input device configured to receive a claim request from a user desiring to claim one or more print requests, the claim request including charge account information;
identification logic configured to identify one or more print requests for which the user is an owner based, at least in part, on the claim request, and configured to cause the identified one or more print requests to be processed; and
a payment logic configured to charge an account using the charge account information from the claim request.

2. The system of claim 1 where the input device includes a card reader configured to read identification data from an identification card provided by the user to claim one or more delayed print requests, the claim request being formed from the identification data.

3. The system of claim 2 where each print request includes an owner identification, and the identification logic being configured to compare the identification data provided by the user to the owner identification to determine a match.

4. The system of claim 1 where the claim request is configured to be received from a single data input.

5. The system of claim 1 where the claim request is configured to serve as both identifying information for print requests and charging information.

6. The system of claim 1 wherein the input device includes a key pad configured to allow a user to input an identification code, the claim request being formed using at least the identification code.

7. The system of claim 6 where each print request includes an owner identification, and the identification logic being configured to compare the identification code provided by the user to the owner identification to determine a match.

8. The system of claim 1 where the system includes one of, an image forming device, and a computer system in communication with an image forming device.

9. The system of claim 1 further including a data store configured to maintain the print requests delayed by the print delay logic.

10. The system of claim 1 where the input device being configured to receive the claim request from the user being in a physical vicinity of the image forming device.

11. A computer-readable medium including processor executable instructions for processing print requests for an image forming device, the processor executable instructions being configured to perform a method comprising:
receiving a print request that includes an associated user identification;
delaying processing of the print request in the image forming device until claimed by a user;
in response to receiving claim data from a user in the presence of the image forming device, comparing the claim data with the user identification associated to the maintained print request;
processing the print request if the user identification matches the claim data; and
charging an account using information from the claim data.

12. The computer-readable medium as set forth in claim 11 where the claim data is received by an input device directly connected to the image forming device.

13. The computer-readable medium as set forth in claim 11 further including maintaining received print requests in a queue where the received print requests are received from one or more sources and one or more users.

14. The computer-readable medium as set forth in claim 11 where the charging step further includes automatically charging a user account for the claimed print request based on the user identification associated with the print request.

15. The computer-readable medium as set forth in claim 14 where the user identification includes credit card information.

16. The computer-readable medium as set forth in claim 14 further including instructions configured to perform a pre-authorization on the user account prior to processing the print request.

17. The computer-readable medium as set forth in claim 11 where the user identification is configured as a sub-set of the claim data.

18. A method of processing print requests in an image forming device, the method comprising:
maintaining one or more pending print requests until physically claimed by a user, each print request being stored with an associated user identification;
in response to receiving user claim data physically inputted into the image forming device by a user in order to claim a pending print request, determining a claimed print request from the one or more pending print requests that belong to the user based on the user claim data;
selecting the claimed print request for processing into a printed copy; and
using the user claim data to charge a user account for processing the claimed print request.

19. The method as set forth in claim 18 further including displaying the print requests selected and allowing the user to initiate printing of one or more print requests displayed.

20. The method as set forth in claim 18 where the selecting includes activating a pending print request.

21. The method as set forth in claim 18 where determining includes comparing the associated user identification from the one or more print requests with the user claim data.

22. The method as set forth in claim 18 where the user claim data includes credit card information.

23. The method as set forth in claim 18 where the determining step includes determining all claimed print requests that belong to the user from the one or more pending print requests.

24. The method as set forth in claim 18 where the user claim data is received from a single data input from the user.

25. The method as set forth in claim 24 further including:
determining a cost associated to processing the claimed print request;
verifying the user account; and
charging the user account based on the cost prior to processing the claimed print request.

26. An image forming device comprising:
a data store configured to maintain print requests, each print request including owner information associated thereto;
an input device configured to read a credit card provided by a user and to obtain credit card data from the credit card; and
a print request processing means including:
print delay means for delaying processing of each of the print requests in the data store until claimed by an owner of the print request;
identification means for identifying which of the print requests in the data store are owned by the user by comparing the credit card data with the owner information associated with the print requests; and
payment means configured to charge the credit card read by the input device if one or more print requests are identified by the identification logic.

27. The image forming device as set forth in claim 26 further including a chai service configured to control the print request processing means.

28. The image forming device as set forth in claim 26 further including a chaiwood server configured to control the print request processing means.

29. The image forming device as set forth in claim 26 further including a display configured to display the print requests identified as owned by the user.

30. The image forming device as set forth in claim 26 further including imaging logic configured to cause the image forming device to print the print requests identified by the identification means.

31. A print driver comprising:
logic configured to generate a print request based on a selected data desired to be printed; and
logic configured to obtain, from a user, owner identification data to be associated with the print request, the print request being configured to be maintained in a pending state in an image forming device until physically claimed by the user by providing a claim data to the image forming device that matches the owner identification data, the claim data including identification information to identify the print request and charging information to charge a user account for processing the print request.

32. A graphical user interface comprising:
logic configured to receive data representing one or more print requests that belong to a user that has claimed the one or more print requests by inputting claim data that matches owner identification data associated with the one or more print requests, the user being in the vicinity of an image forming device, and
logic configured to display the one or more print requests belonging to the user and allowing selection of the one or more print requests for processing onto a print media.
